(19) United States
(12) Patent Application Publication
(10) Pub. No.: US 2025/0225998 A1
(43) Pub. Date: Jul. 10, 2025

(54) SPEAKER DIARIZATION POST-PROCESSING WITH LARGE LANGUAGE MODELS

(71) Applicant: Google LLC, Mountain View, CA (US)

(72) Inventors: Quan Wang, Hoboken, NJ (US); Wei Xia, New York, NY (US); Guanlong Zhao, Long Island City, NY (US); Evan Clark, San Francisco, CA (US); Yiling Huang, Edgewater, NJ (US); Hank Liao, New York, NY (US)

(73) Assignee: Google LLC, Mountain View, CA (US)

(21) Appl. No.: 19/009,839

(22) Filed: Jan. 3, 2025

Related U.S. Application Data
(60) Provisional application No. 63/618,019, filed on Jan. 5, 2024.

(51) Int. Cl. G10L 21/028; G10L 17/02

(52) U.S. Cl. CPC G10L 21/028; G10L 17/02

(57) ABSTRACT

A method includes receiving audio data including a plurality of spoken terms spoken by one or more speakers during a conversation. The method includes generating diarization results based on the plurality of spoken terms spoken by the one or more speakers during the conversation. The diarization results include a speech recognition result including a series of predicted terms and a series of identity-agnostic speaker tokens. The method also includes processing the diarization results conditioned on a diarization prompt to predict, as output from an LLM, updated diarization results. The updated diarization results include the speech recognition result including the series of predicted terms and a series of identity-specific speaker tokens.

### CROSS REFERENCE TO RELATED APPLICATIONS

This U.S. patent application claims priority under 35 U.S.C. § 119 (e) to U.S. Provisional Application 63/618,019, filed on Jan. 5, 2024. The disclosure of this prior application is considered part of the disclosure of this application and is hereby incorporated by reference in its entirety.

### TECHNICAL FIELD

This disclosure relates to speaker diarization post-processing with large language models.

### BACKGROUND

Speaker diarization is the process of partitioning an input audio stream into homogenous segments according to speaker identity. In an environment with multiple speakers, speaker diarization answers the question “who is speaking when” and has a variety of applications including multimedia information retrieval, speaker turn analysis, audio processing, and automatic transcription of conversation, to name a few. For example, speaker diarization involves the task of annotating speaker turns in a conversation by identifying that a first segment of an input audio stream is attributable to a first human speaker (without particularly identifying who the first human speaker is), and a second segment of the input audio stream is attributable to a different second human speaker (without particularly identifying who the second human speaker is), a third segment of the input audio stream is attributable to the first human speaker, etc. Despite performance advances of speaker diarization models, diarization results still oftentimes include errors.

### SUMMARY

One aspect of the disclosure provides a computer-implemented method executed on data processing hardware that causes the data processing hardware to perform operations for speaker diarization post-processing. The operations include receiving audio data including a plurality of spoken terms spoken by one or more speakers during a conversation. Using a joint speech recognition and speaker diarization model, the operations include generating diarization results based on the plurality of spoken terms spoken by the one or more speakers during the conversation. The diarization results include a speech recognition result including a series of predicted terms and a series of identity-agnostic speaker tokens. Each respective predicted term from the series of predicted terms is aligned with a corresponding identity-agnostic speaker token from the series of identity-agnostic speaker tokens and each corresponding identity-agnostic speaker token represents a generic identity of a respective one of the speakers that spoke the respective predicted term. Using a large language model (LLM), the operations include processing the diarization results conditioned on a diarization prompt to predict, as output from the LLM, updated diarization results. The diarization results include the speech recognition result including the series of predicted terms and a series of identity-specific speaker tokens. Each respective predicted term from the series of predicted terms is aligned with a corresponding identity-specific speaker token from the series of identity-specific speaker tokens and each corresponding identity-specific speaker token representing a particular identity of a respective one of the speakers that spoke the respective predicted term.

Implementations of the disclosure may include one or more of the following optional features. In some implementations, the corresponding identity-specific speaker token does not reveal the particular identity of the respective one of the speakers that spoke the respective predicted term. The particular identity may include a name or role of the respective one of the speakers that spoke the respective predicted term. In some examples, processing the diarization results to predict updated diarization results includes replacing the identity-agnostic speaker tokens with identity-specific speaker tokens. Processing the diarization results to predict updated diarization results includes identifying, from the diarization results, a predicted term misaligned with a corresponding identity-agnostic speaker token using semantic interpretation, realigning the identified predicted term with another one of the identity-agnostic speaker tokens from the series of identity-agnostic speaker tokens, and generating the updated diarization results based on the realigned predicted term.

In some implementations, the LLM is pre-trained on a diverse range of text data sourced from web documents, books, and code. The operations may further include fine-tuning the LLM on training examples to perform post-processing on the diarization results. In some examples, the diarization prompt includes a single-shot learning example. In these examples, the single-shot learning example includes an example input and output for conditioning the LLM. The diarization prompt includes context data associated with the conversation.

Another aspect of the disclosure provides a system that includes data processing hardware and memory hardware storing instructions that when executed on the data processing hardware causes the data processing hardware to perform operations. The operations include receiving audio data including a plurality of spoken terms spoken by one or more speakers during a conversation. Using a joint speech recognition and speaker diarization model, the operations include generating diarization results based on the plurality of spoken terms spoken by the one or more speakers during the conversation. The diarization results include a speech recognition result including a series of predicted terms and a series of identity-agnostic speaker tokens. Each respective predicted term from the series of predicted terms is aligned with a corresponding identity-agnostic speaker token from the series of identity-agnostic speaker tokens and each corresponding identity-agnostic speaker token represents a generic identity of a respective one of the speakers that spoke the respective predicted term. Using a large language model (LLM), the operations include processing the diarization results conditioned on a diarization prompt to predict, as output from the LLM, updated diarization results. The diarization results include the speech recognition result including the series of predicted terms and a series of identity-specific speaker tokens. Each respective predicted term from the series of predicted terms is aligned with a corresponding identity-specific speaker token from the series of identity-specific speaker tokens and each corresponding identity-specific speaker token representing a particular identity of a respective one of the speakers that spoke the respective predicted term.

Implementations of the disclosure may include one or more of the following optional features. In some implementations, the corresponding identity-specific speaker token does not reveal the particular identity of the respective one of the speakers that spoke the respective predicted term. The particular identity may include a name or role of the respective one of the speakers that spoke the respective predicted term. In some examples, processing the diarization results to predict updated diarization results includes replacing the identity-agnostic speaker tokens with identity-specific speaker tokens. Processing the diarization results to predict updated diarization results includes identifying, from the diarization results, a predicted term misaligned with a corresponding identity-agnostic speaker token using semantic interpretation, realigning the identified predicted term with another one of the identity-agnostic speaker tokens from the series of identity-agnostic speaker tokens, and generating the updated diarization results based on the realigned predicted term.

In some implementations, the LLM is pre-trained on a diverse range of text data sourced from web documents, books, and code. The operations may further include fine-tuning the LLM on training examples to perform post-processing on the diarization results. In some examples, the diarization prompt includes a single-shot learning example. In these examples, the single-shot learning example includes an example input and output for conditioning the LLM. The diarization prompt includes context data associated with the conversation.

Another aspect of the disclosure provides a computer-implemented method executed on data processing hardware that causes the data processing hardware to perform operations for speaker diarization post-processing. The operations include receiving audio data including a plurality of spoken terms spoken by one or more speakers during a conversation. Using a joint speech recognition and speaker diarization model, the operations include generating diarization results based on the plurality of spoken terms spoken by the one or more speakers during the conversation. The diarization results include a speech recognition result including a series of predicted terms and a series of identity-agnostic speaker tokens. Using a large language model (LLM), the operations include processing the diarization results conditioned on a diarization prompt to predict, as output from the LLM, updated diarization results.

Implementations of the disclosure may include one or more of the following optional features. In some implementations, each respective predicted term is associated with a starting speech timestamp and an ending speech timestamp and each identity-agnostic speaker token is associated with a starting speaker token timestamp and an ending speaker token timestamp. In these implementations, the series of predicted terms may not be aligned with the series of identity-agnostic speaker tokens. Here, processing the diarization results conditioned on the diarization prompt to predict the updated diarization results includes aligning each respective predicted term from the series of predicted terms with a corresponding identity-agnostic speaker token from the series of identity-agnostic speaker tokens and generating the updated diarization results based on the alignment.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system that executes a joint speech recognition and speaker diarization model.

FIG. 2 is a schematic view of an example automatic speech recognition model.

FIG. 3 is a schematic view of a first configuration of a large language model post-processing diarization results.

FIG. 4 is a schematic view of a second configuration of a large language model post-processing diarization results.

FIG. 5 is a schematic view of a third configuration of a large language model post-processing diarization results.

FIG. 6 is a schematic view of a fourth configuration of a large language model post-processing diarization results.

FIG. 7 is a flowchart of an example arrangement of operations for a computer-implemented method of performing speaker diarization post-processing using a large language model.

FIG. 8 is a flowchart of an example arrangement of operations for another computer-implemented method of performing speaker diarization post-processing using a large language model.

FIG. 9 is a schematic view of an example computing device that may be used to implement the systems and methods described herein.

Like reference symbols in the various drawings indicate like elements.

### DETAILED DESCRIPTION

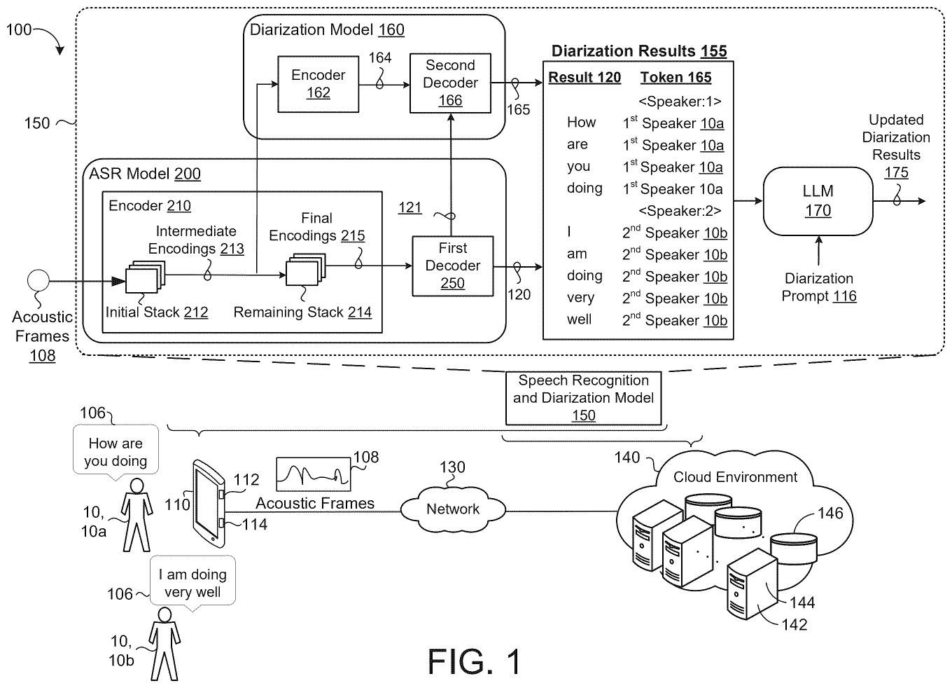

Referring to FIG. 1, a system 100 includes a user device 110 capturing speech utterances 106 spoken by multiple speakers (e.g., users) 10, 10a-n during a conversation and communicating with a remote system 140 via network 130. The remote system 140 may be a distributed system (e.g., cloud computing environment) having scalable/elastic resources 142. The resources 142 include computing resources 144 (e.g., data processing hardware) and/or storage resources 146 (e.g., memory hardware). In some implementations, the user device 110 and/or the remote system 140 executes a joint speech recognition and speaker diarization model 150 that is configured to receive a sequence of acoustic frames (i.e., audio data) 108 that corresponds to captured speech utterances 106 spoken by the multiple speakers 10 during the conversation and generate, at each of a plurality of output steps, speech recognition results (e.g., speech recognition hypotheses or transcriptions) 120 corresponding to the captured speech utterances 106 and diarization results 155. The captured speech utterances include a plurality of spoken terms spoken by one or more speakers 10 during the conversation. As will become apparent, the speech recognition results 120 indicate “what” was spoken during the conversation and the diarization results 155 indicate “who” spoke each word/wordpiece of the speech recognition results 120. Thus, the speech recognition result 120 includes a series of predicted terms spoken by the speakers 10. In the example shown, the joint speech recognition and speaker diarization model 150 includes an automatic speech recognition (ASR) model 200 and a diarization model 160 as separate models which produce the diarization results 155 having word-level results that represent who spoke each word/wordpiece. In other examples, the joint speech recognition and speaker diarization model 150 may include the ASR model 200 and the diarization model 160 as a single model that produces the diarization results 155 having frame-level results that represent who spoke during each acoustic frame 108.

The user device 110 includes data processing hardware 112 and memory hardware 114. The user device 110 may include an audio capture device (e.g., microphone) for capturing and converting the speech utterances 106 (also referred to as simply “utterances 106”) from the multiple speakers 10 into the sequence of acoustic frames 108 (e.g., input audio data). In some implementations, the user device 110 is configured to execute a portion of the joint speech recognition and speaker diarization model 150 locally (e.g., using the data processing hardware 112) while a remaining portion of the joint speech recognition and speaker diarization model 150 executes on the cloud computing environment 140 (e.g., using data processing hardware 144).

Alternatively, the joint speech recognition and speaker diarization model 150 may execute entirely on the user device 110 or the cloud computing environment 140. The user device 110 may be any computing device capable of communicating with the cloud computing environment 140 through the network 130. The user device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

In the example shown, the multiple speakers 10 and the user device may be located within an environment (e.g., a room) where the user device 110 is configured to capture and convert the speech utterances 106 spoken by the multiple speakers 10 into the sequence of acoustic frames 108. For instance, the multiple speakers 10 may correspond to co-workers having a conversation during a meeting and the user device 110 may record and convert the speech utterances 106 into the sequence of acoustic frames 108 In turn, the user device 110 may provide the sequence of acoustic frames 108 to the joint speech recognition and speaker diarization model 150 to generate speech recognition results 120 and diarization results 155.

In some examples, at least a portion of the speech utterances 106 conveyed in the sequence of acoustic frames 108 are overlapping, such that, at a given instant in time, two or more speakers 10 are speaking simultaneously. Notably, a number N of the multiple speakers 10 may be unknown when the sequence of acoustic frames 108 are provided as input to the joint speech recognition and speaker diarization model 150 whereby the joint speech recognition and speaker diarization model 150 predicts the number N of the multiple speakers 10. In some implementations, the user device 110 is remotely located from the one or more of the multiple speakers 10. For instance, the user device 110 may include a remote device (e.g., network server) that captures speech utterances 106 from the multiple speakers 10 that are participants in a phone call or video conference. In this scenario, each speaker 10 would speak into their own user device 110 (e.g., phone, radio, computer, smartwatch, etc.) that captures and provides the speech utterances 106 to the remote user device for converting the speech utterances 106 into the sequence of acoustic frames 108. Of course in this scenario, the speech utterances 106 may undergo processing at each of the user devices 110 and be converted into a corresponding sequence of acoustic frames 108 that are transmitted to the remote user device which may additionally process the sequence of acoustic frames 108 provided as input to the joint speech recognition and speaker diarization model 150.

The ASR model 200 of the joint speech recognition and speaker diarization model 150 includes an audio encoder 210 and a first decoder 250. The diarization model 160 of the joint speech recognition and speaker diarization model 150 includes a diarization encoder 162 and a second decoder 166. In the example shown, the first decoder 250 is independent and separate from the second decoder 166, however, in other examples, the first decoder 250 and the second decoder 166 may be the same decoder producing a single output. Moreover, in the example shown, only two speakers (e.g., a first speaker 10, 10a and a second speaker 10, 10b) are participating in the conversation for the sake of clarity only, as it is understood that any number of speakers 10 may speak during the conversation. In this example, the first speaker 10a speaks “how are you doing” and the second speaker 10b responds by speaking “I am doing very well.” The ASR model 200 is configured to generate the speech recognition results 120 representing “what” was spoken by the multiple speakers 10 during the conversation by processing the sequence of acoustic frames 108.

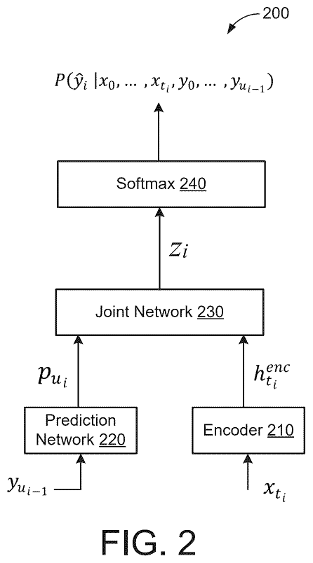

Referring now to FIG. 2, in some implementations, the ASR model 200 includes a Recurrent Neural Network-Transducer (RNN-T) model architecture which adheres to latency constraints with interactive applications. The use of the RNN-T model architecture is exemplary only, as the ASR model 200 may include other architectures such as transformer-transducer and conformer-transducer model architectures, among others. The RNN-T model 200 provides a small computational footprint and utilizes less memory requirements than conventional ASR architectures, making the RNN-T model architecture suitable for performing speech recognition entirely on the user device 110 (e.g., no communication with a remote server is required). The RNN-T model 200 includes an encoder network (e.g., audio encoder) 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the audio encoder 210 reads a sequence of d-dimensional features vectors (e.g., acoustic frames 108 (FIG. 1)) x=(x₁, x₂, . . . , x_{T}), where xₜ∈R_{d}, and produces at each output step a higher-order feature representation (e.g., audio encoding). This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}; Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network 230 then predicts P(ŷᵢ|x₀, . . . , xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the speech recognition result (e.g., transcription) 120 (FIG. 1).

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics, but also on the sequence of labels output so far. The RNN-T model 200 does assume an output symbol is independent of future acoustic frames 108, which allows the RNN-T model to be employed in the streaming fashion, the non-streaming fashion, or some combination thereof.

In some examples, the audio encoder 210 of the RNN-T model includes a plurality of multi-head (e.g., 8 heads) self-attention layers. For example, the plurality of multi-head self-attention layers may include Conformer layers (e.g., Conformer-encoder), transformer layers, performer layers, convolution layers (including lightweight convolution layers), or any other type of multi-head self-attention layers. The plurality of multi-head self-attention layers may include any number of layers, for instance, 16 layers. Moreover, the audio encoder 210 may operate in the streaming fashion (e.g., the audio encoder 210 outputs initial higher-order feature representations as soon as they are generated), in the non-streaming fashion (e.g., the audio encoder 210 outputs subsequent higher-order feature representations by processing additional right-context to improve initial higher-order feature representations), or in a combination of both the streaming and non-streaming fashion.

Referring back to FIG. 1, in some examples, the audio encoder 210 includes a stack of audio encoder layers 212, 214 having multi-head self-attention layers (e.g., conformer, transformer, convolutional, or performer layers) or a recurrent network of Long Short-Term Memory (LSTM) layers. For instance, the audio encoder 210 receives, as input, the sequence of acoustic frames 108 and generates, at each of the plurality of output steps, corresponding audio encodings 213, 215. More specifically, an initial stack of audio encoder layers 212 generates, at each output step, a corresponding sequence of intermediate audio encodings 213 from the sequence of acoustic frames 108. Thereafter, a remaining stack of the audio encoder layers 214 generates, at each output step, a corresponding sequence of final audio encodings 215 based on the sequence of intermediate audio encodings 213. For example, the stack of audio encoder layers 212, 214 may include sixteen (16) conformer layers where the initial stack of audio encoder layers 212 (e.g., four (4) conformer layers) generates the corresponding sequence of intermediate audio encodings 213 based on the sequence of acoustic frames 108 and the remaining stack of audio encoder layers 214 (e.g., the remaining twelve (12) conformer layers) generates the corresponding sequence of final audio encodings 215 from the sequence of intermediate audio encodings 213.

Notably, some information is discarded (e.g., background noise) as the initial stack of audio encoder layers 212 generates the sequence of intermediate audio encodings 213, but speaker characteristic information is maintained. Here, the speaker characteristic information refers to the speaking traits or style of a particular user, for example, prosody, accent, dialect, cadence, pitch, etc. However, after generating the intermediate audio encodings 213, the speaker characteristic information may also be discarded as the remaining stack of audio encoder layers 214 generates the sequence of final audio encodings 215. That is, because the ASR model 200 is configured to predict “what” was spoken, the remaining stack of audio encoder layers 214 may filter out the speaker characteristic information (e.g., indicating voice characteristics of the particular user speaking) because voice characteristics pertaining to particular speakers are not needed to predict “what” was spoken and are only relevant when predicting “who” is speaking.

On the other hand, the diarization model 160 may leverage the speaker characteristic information to improve accuracy of predicting “who is speaking when,” because voice characteristics pertaining to particular speakers is helpful information when identifying who is speaking. Thus, because the sequence of intermediate audio encodings 213 includes the speaker characteristic information from the sequence of acoustic frames 108 (e.g., that may be subsequently discarded by the remaining stack of audio encoder layers 214), the intermediate audio encodings 213 advantageously enable the diarization model 160 to more accurately predict who is speaking each term (e.g., word, wordpiece, grapheme, etc.) of the speech recognition results 120. The first decoder 250 of the ASR model 200 is configured to receive, as input, the sequence of final audio encodings 215 generated by the remaining stack of audio encoder layers 214 and generate, at each of the plurality of output steps, a corresponding speech recognition result 120. The speech recognition 120 result may include a probability distribution over possible speech recognition hypotheses (e.g., words, wordpieces, graphemes, etc.) whereby the diarization results 155 are word-level, wordpiece-level, or grapheme-level results. In some examples, the speech recognition results 120 include blank logits 121 denoting that no terms are currently being spoken at the corresponding output step. As will become apparent, the first decoder 250 may output the blank logits 121 and/or the speech recognition results 120 (not shown) to the second decoder 166 such that the second decoder 166 only outputs speaker tokens when the first decoder 250 outputs non-blank speech recognition results 120.

The first decoder 250 may include an RNN-T architecture having a joint network and a prediction network (e.g., the joint network 220 and the prediction network 230). Thus, the first decoder 250 uses the joint network to combine the sequence of final audio encodings 215 generated by the remaining stack of encoder layers 214 and an audio embedding output generated by the prediction network for the previous prediction to generate the speech recognition results 120. Although not illustrated, in some examples, the first decoder 250 includes a Softmax layer (e.g., the Softmax layer 240 (FIG. 2)) that receives the output of the first decoder 250. In some implementations, the Softmax layer is separate from the first decoder 250 and processes the output from the first decoder 250. Thus, the output of the Softmax layer is then used in a beam search process to select orthographic elements to generate the speech recognition result 120. In some implementations, the Softmax layer is integrated with the first decoder 250, such that the output of the first decoder 250 represents the output of the Softmax layer.

The diarization model 160 is configured to generate, for each speech recognition result 120 generated by the first decoder 250 of the ASR model 200, a respective identity-agnostic speaker token 165 representing a predicted generic identity of the respective speaker 10 from the multiple speakers 10 speaking during the conversation. Thus, the diarization model 160 generates a series of identity-agnostic speaker tokens 165 for the conversation whereby each respective predicted term is aligned with a corresponding identity-agnostic speaker token 165. Notably, the identity-agnostic speaker token 165 does not reveal the particular identity (e.g., name or role) of the speaker 10 from the multiple speakers 10 speaking during the conversation, but rather reveals a generic identity (e.g., speaker 1, speaker 2, etc.) for each speaker 10 speaking during the conversation. For example, the identity-agnostic speaker token 165 generated for a conversation between Bob and Jim include “<Speaker: 1>” and “<Speaker: 2>.” In this example, the identity-agnostic speaker tokens 165 are generic identity labels that do not reveal the actual identity or role of the speakers Bob or Jim. Thus, an observer would only be able to discern whether “<Speaker: 1>” or “<Speaker: 2”> is speaking based on the identity-agnostic speaker tokens 165, but would not be able to discern whether Bob or Jim was speaking. Stated differently, the observer would be unable to correlate which identity-agnostic speaker token 165 correlates to Bob or Jim. In some examples, the identity-agnostic speaker tokens 165 do not reveal the identities of the speakers 10 because the diarization model 160 does not perform speaker identification (e.g., for speakers with enrolled speaker profiles). As such, the diarization model 160 may generate the identity-agnostic speaker tokens 165 for both un-enrolled speakers and enrolled speakers.

The respective identity-agnostic speaker tokens 165 generated by the diarization model 160 are word-level, wordpiece-level, or grapheme-level in connection with the ASR model 200 generating word-level, wordpiece-level, or grapheme-level speech recognition results 120, respectively. In particular, the diarization encoder 162 of the diarization model 160 receives, as input, the sequence of intermediate audio encodings 213 generated by the initial stack of audio encoder layers 212 and generates, at each of the plurality of output steps, a corresponding sequence of diarization encodings 164 based on the sequence of the intermediate audio encodings 213. Notably, as discussed above, the sequence of intermediate audio encodings 214 may retain speaker characteristic information associated with the speaker 10 that is currently speaking to predict the identity of the speaker 10.

In some implementations, the diarization encoder 162 includes a memory unit that stores the previously generated diarization encodings 164 generated at prior output steps during the conversation. In contrast to the ASR model 200 which transcribes speech into text based on current audio data input, the diarization model 160 needs to retain the identity-agnostic speaker tokens 165 generated throughout the entire conversation. For example, the speech recognition and speaker diarization model 150 may process audio data for a video that is multiple hours long where one of the speakers only spoke during the first minute of the conversation and the last minute of the conversation. In this example, the diarization model 160 needs to retain the embedding information for this speaker throughout the entire hours-long conversation. The memory unit may include the memory hardware 114 from the user device 110 and/or the memory hardware 146 from the cloud computing environment 140. In particular, the diarization model 160 may include a recurrent neural network that has a stack of long short-term memory (LSTM) layers or a stack of multi-headed self-attention layers (e.g., conformer layers or transformer layers). Here, the stack of LSTM layers or multi-head self-attention layers serve as the memory unit and store the previously generated diarization encodings 164. As such, the diarization encoder 162 may generate, at a current output step, a corresponding diarization encoding 164 based on the previous diarization encodings 164 generated for the preceding output steps during the conversation and the intermediate audio encodings 213 corresponding to the current output step. Advantageously, using the previous diarization encodings 164 provides the diarization model 160 more context for predicting which particular speaker 10 is currently speaking based on previous words the particular speaker 10 may have spoken during the conversation.

In some implementations, the diarization model 160 includes a plurality of diarization encoders 162 (e.g., K number of diarization encoders) (not shown) whereby K is equal to the number of speakers 10 speaking during the conversation. Stated differently, each diarization encoder 162 of the K number of diarization encoders 162 may be assigned to a particular one of the speakers 10 from the conversation. Moreover, each diarization encoder 162 of the K number of diarization encoders 162 is configured to receive a Kth intermediate audio encoding 213 from the audio encoder 210. Here, each of the Kth intermediate audio encodings 213 is associated with a respective one of the speakers 10 and is output to a corresponding diarization encoder 162 associated with the respective one of the speakers 10.

Thereafter, the second decoder 166 receives the sequence of diarization encodings 164 generated by the diarization encoder 162 and generates, for each respective speech recognition result 120 output by the ASR model 200, the respective identity-agnostic speaker token 165 representing a predicted generic identity (e.g., speaker 1, speaker 2, etc.) of the speaker 10 from the multiple speakers 10 that spoke the corresponding term from the speech recognition results 120. That is, the ASR model 200 may output speech recognition results 120 at each output step of the plurality of output steps whereby the speech recognition results 120 include blank logits 121 where no speech is currently present. In contrast, the second decoder 166 is configured to receive the blank logits 121 and/or speech recognition results 120 (not shown) from the ASR model 200 such that the second decoder 166 only generates the identity-agnostic speaker tokens 165 when the ASR model 200 generates speech recognition results 120 that include a spoken term. For example, for a conversation that includes ten (10) words, the second decoder 166 generates a corresponding ten (10) identity-agnostic speaker tokens 165 (e.g., one speaker token for each word recognized by the ASR model 200).

The second decoder 166 may include a RNN-T architecture having a joint network (e.g., the joint network 230 (FIG. 2)). Optionally, the second decoder 166 may include a prediction network (e.g., the prediction network 220 (FIG. 2)). Thus, the second decoder 166 uses the joint network to process the sequence of diarization encodings 164 generated by the diarization encoder 162 to generate the identity-agnostic speaker token 165. When second decoder 166 includes the prediction network, the joint network combines the sequence of diarization encodings 164 with an audio embedding output 222 generated by the prediction network for the previous prediction. Although not illustrated, in some examples, the second decoder 166 includes a Softmax layer (e.g., the Softmax layer 240 (FIG. 2)) that receives the output of the second decoder 166. In some implementations, the Softmax layer is separate from the second decoder 166 and processes the output from the second decoder 166. Thus, the output of the Softmax layer is then used in a beam search process to select orthographic elements to generate the identity-agnostic speaker token 165. In some implementations, the Softmax layer is integrated with the first decoder 250, such that the output of the first decoder 250 represents the output of the Softmax layer. Moreover, the second decoder 166 may receive the blank logits 121 from the ASR model 200 such that the second decoder 166 only outputs the identity-agnostic speaker tokens 165 for non-blank logits. That is, by receiving the blank logits 121, the second decoder 166 synchronizes generating the identity-agnostic speaker tokens 165 with the speech recognition results 120.

In some implementations, the joint speech recognition and speaker diarization model 150 combines the speech recognition results 120 generated by the ASR model 200 and the identity-agnostic speaker tokens 165 generated by the diarization model 160 to generate the diarization results 155. That is, the diarization results 155 indicate, for each respective term (e.g., word, wordpiece, and/or grapheme) of the speech recognition results 120 generated by the ASR model 200, an identity of the corresponding speaker 10 form the multiple speakers 10 that spoke the respective term of the speech recognition results 120. Thus, as the speech recognition results 120 include words, wordpieces, and/or graphemes, the diarization results 155 are similarly word-level, wordpiece-level, and/or graphemes, the diarization results 155 are similarly word-level, wordpiece-level, and/or grapheme-level respectively.

Continuing with the example shown, the ASR model 200 recognizes word-level speech recognition results 120 of “How are you doing I am doing very well” and the diarization model 160 generates a corresponding identity-agnostic speaker token 165 for each spoken word from the speech recognition results 120. In this example, the corresponding identity-agnostic speaker tokens 165 indicate that the first speaker 10a spoke the words “How are you doing” and the second speaker 10b spoke the words “I am doing very well” during the conversation. Thus, by combining the speech recognition results 120 and the identity-agnostic speaker tokens 165, the joint speech recognition and speaker diarization model 150 generates word-level diarization results 155 because the corresponding speech recognition results 120 output by the ASR model are word-level. In some examples, the diarization model 160 generates the identity-agnostic speaker token 165 which includes speaker turn labels denoting the transition between speakers talking. For instance, the diarization results 155 include the identity-agnostic speaker token 165 including the speaker turn label “<Speaker: 1>” before the first speaker 10a starts speaking and the identity-agnostic speaker token 165 including the speaker turn label “<Speaker: 2>” as the second speaker 10b starts speaking. The diarization results 155 may be stored at the memory hardware 114, 146 for the subsequent retrieval by one or more of the user devices 110.

The LLM 170 is configured to receive the diarization results 155 and a diarization prompt 116, as input, and generate updated diarization results 175. The LLM 170 may receive the diarization results 155 after the joint speech recognition and the speaker diarization model 150 processes the sequence of acoustic frames 108 for the entire conversation or at predetermined intervals during the conversation. As such, the LLM 170 post-processes the diarization results 155 to correct errors, if any, included in the diarization results 155. The diarization prompt 116 may be generated by a user 10 associated with one of the user device 110. For instance, the user 10 may speak the diarization prompt 116 or type the diarization prompt 116 via the user device 110. The diarization prompt 116 specifies particular post-processing for the LLM 170 to perform on the diarization results 155. Thus, the LLM 170 processes the diarization results 155 and is conditioned on the diarization prompt 116 to generate the updated diarization results 175.

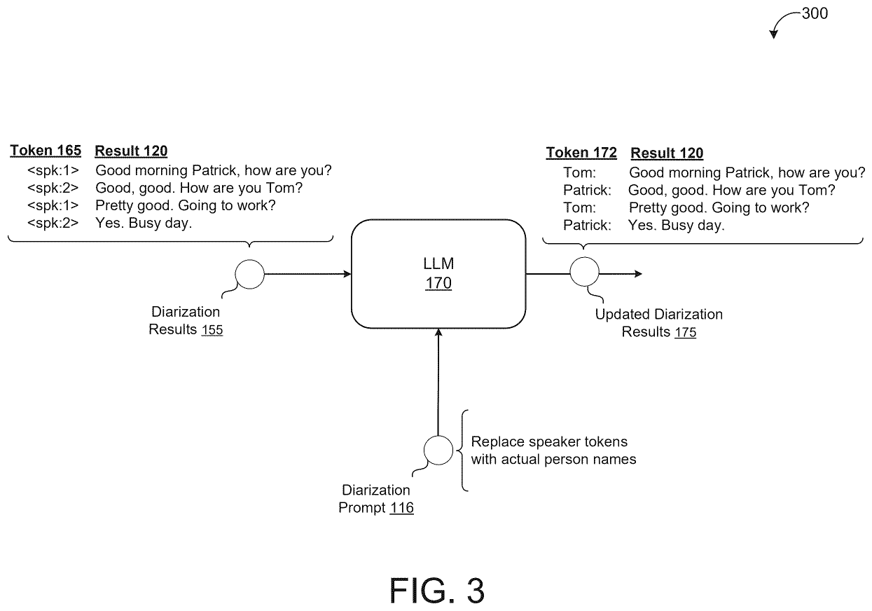

FIG. 3 illustrates a first configuration 300 of the LLM 170 post-processing the diarization results 155. In the first configuration 300, the LLM 170 receives diarization results 155 generated from a conversation between two speakers, Patrick and Tom. Here, the diarization results 155 include the identity-agnostic speaker tokens 165 and corresponding speech recognition results 120. Notably, the identity-agnostic speaker tokens 165 only include “<spk: 1>” and “<spk: 2>” labels that do not reveal the identity of Patrick or Tom. Yet, in some scenarios, having speaker tokens that are not generic and actually indicate which speech recognition results 120 were spoken by Patrick and Tom, respectively, is beneficial. To that end, in the first configuration 300, the diarization prompt 116 requests the LLM 170 to replace the identity-agnostic speaker tokens 165 with identity-specific speaker tokens 172. More specifically, the diarization prompt 116 requests the LLM 170 to “replace speaker tokens with actual person names.” The identity-specific speaker tokens 172 specifically represent the identity of the speaker. The diarization prompt 116 may include natural language text.

In some examples, the diarization prompt 116 may include the names of the speaker from the conversation such that the LLM 170 does not have to determine the speaker names from the speech recognition results 120. For instance, the diarization prompt 116 may include “replace speaker tokens with actual person names for the conversation between Patrick and Tom.” In other examples, the diarization prompt 116 does not include the names of the speakers from the conversation such that the LLM does have to determine the speaker names from the speech recognition results 120. In some implementations, the diarization prompt 116 includes context data associated with the conversation from which the diarization results 155 were generated. That is, the diarization results 155 may be generated from a video that has a textual video description. Here, the textual video description may be included as part of the diarization prompt 116.

In the example shown, the LLM 170 processes the diarization results 155 and is conditioned on the diarization prompt 116 to generate the updated diarization results 175. Notably, the updated diarization results 175 are similar to the diarization results 155 except that the updated diarization results 175 replace the identity-agnostic speaker tokens 165 with the identity-specific speaker tokens 172. That is, the LLM 170 processes the diarization results 155 to determine that the identity-agnostic speaker token 165 of “<spk: 1>” corresponds to Tom speaking during the conversation and the identity-agnostic speaker token 165 of “<spk: 2>” corresponds to Patrick speaking during the conversation. In particular, the LLM 170 may determine that the identity-agnostic speaker token 165 of “<spk: 1>” corresponds to Tom based on the first speech recognition result 120 stating “good morning Patrick, how are you?” which Patrick is unlikely to speak in the two speaker conversation. That is, the LLM 170 processes each of the speech recognition results 120 corresponding to the “<spk: 1>” identity-agnostic speaker token 165 and each of the speech recognition results 120 corresponding to the “<spk: 2>” identity-agnostic speaker token 165 to determine that “<spk: 1>” corresponds to Tom speaking and “<spk: 2>” corresponds to Patrick speaking. Thus, each respective predicted term from the series of predicted terms is aligned with a corresponding identity-specific speaker token 172. Moreover, each identity-specific speaker token 172 represents a particular identity (e.g., a name) of a respective one of the speakers that spoke the respective predicted term.

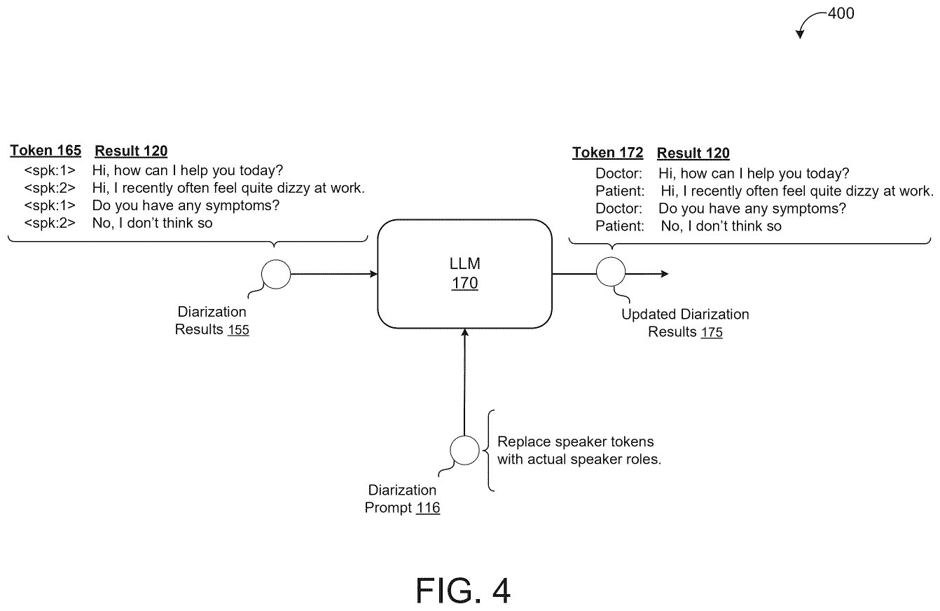

FIG. 4 illustrates a second configuration 400 of the LLM 170 post-processing the diarization results 155. In the second configuration 400, the LLM 170 receives diarization results 155 generated from a conversation between two speakers, a doctor and a patient. Here, the diarization results 155 include the identity-agnostic speaker tokens 165 and corresponding speech recognition results 120. Notably, the identity-agnostic speaker tokens 165 only include “<spk: 1>” and “<spk: 2>” labels that do not reveal the roles of the doctor or the patient. Yet, in some scenarios, having speaker tokens that are not generic and actually indicate which speech recognition results 120 the doctor and patient each respectively spoke is beneficial. To that end, in the second configuration 400, the diarization prompt 116 requests the LLM 170 to replace the identity-agnostic speaker tokens 165 with identity-specific speaker tokens 172 that indicate the role of the speakers from the diarization results 155. Here, the role of the speaker indicates a class of the speaker without revealing the particular identity of the speaker. For example, the role of the speaker may include a doctor, patient, teacher, student, parent, child, etc.

The diarization prompt 116 requests the LLM 170 to “replace speaker tokens with actual speaker roles.” In some examples, the diarization prompt 116 may include the roles of the speakers from the conversation such that the LLM 170 does not have to determine the roles of the speakers from the speech recognition results 120. For instance, the diarization prompt 116 may include “replace speaker tokens with roles like teacher, student, doctor, patient, etc.” In other examples, the diarization prompt 116 does not include the roles of the speakers from the conversation such that the LLM does have to determine the roles of the speakers from the speech recognition results 120. In some implementations, the diarization prompt 116 includes context data associated with the diarization results 155. That is, the diarization results 155 may be generated from a video that has a textual video description. Here, the textual video description may be included as part of the diarization prompt 116.

In the example shown, the LLM 170 processes the diarization results 155 and is conditioned on the diarization prompt 116 to generate the updated diarization results 175. Notably, the updated diarization results 175 are similar to the diarization results 155 except that the updated diarization results 175 replace the identity-agnostic speaker tokens 165 with the identity-specific speaker tokens 172. That is, the LLM 170 processes the diarization results 155 to determine that the identity-agnostic speaker token 165 of “<spk: 1>” corresponds to the doctor speaking during the conversation and the identity-agnostic speaker token 165 of “<spk: 2>” corresponds to the patient speaking during the conversation. In particular, the LLM 170 may determine that the identity-agnostic speaker token 165 of “<spk: 1>” corresponds to the doctor speaking and the identity-agnostic speaker token 165 of “<spk: 2>” corresponds to the patient speaking. That is, the LLM 170 processes each of the speech recognition results 120 corresponding to the “<spk: 1>” identity-agnostic speaker token 165 and each of the speech recognition results 120 corresponding to the “<spk: 2>” identity-agnostic speaker token 165 to determine that “<′spk: 1>” corresponds to the doctor speaking and “<spk: 2>” corresponds to the patient speaking. For instance, the LLM 170 may determine that the speech recognition results 120 of “hi, how can I help you today?” and “do you have any symptoms?” characterize speech that a doctor would ask a patient and determine the identity-specific speaker tokens 172 based on this determination. Thus, each respective predicted term from the series of predicted terms is aligned with a corresponding identity-specific speaker token 172. Moreover, each identity-specific speaker token 172 represents a particular identity (e.g., a role) of a respective one of the speakers that spoke the respective predicted term.

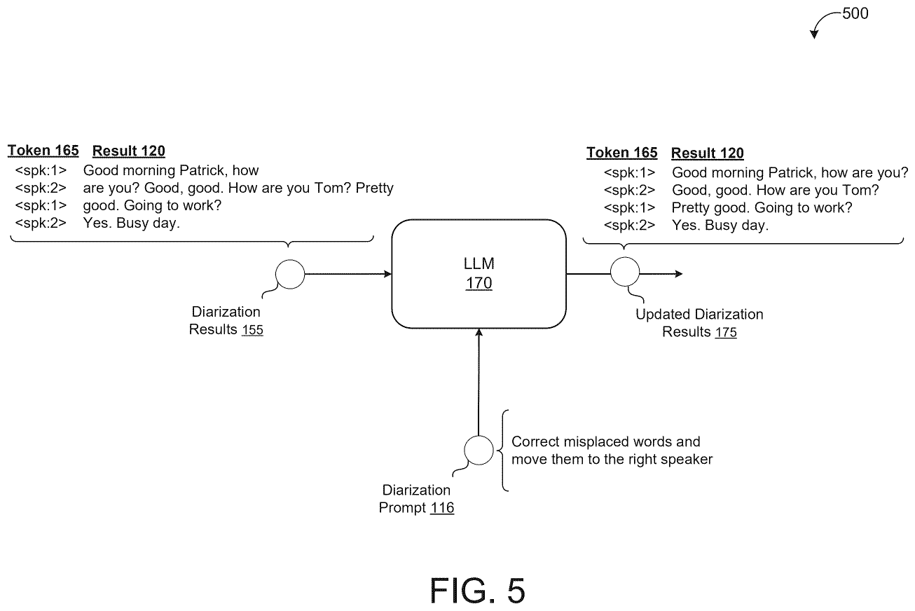

FIG. 5 illustrates a third configuration 500 of the LLM 170 post-processing the diarization results 155. In the third configuration 500, the LLM 170 receives diarization results 155 generated from a conversation between two speakers, Patrick and Tom. Here, the diarization results 155 include the identity-agnostic speaker tokens 165 and corresponding speech recognition results 120. In some instances, the diarization results 155 include few-word off errors. That is, the diarization results 155 may incorrectly assign one or more words near a speaker turn (e.g., transition where one speaker stops speaking and another speaker starts speaking). For instance, in the example shown, the diarization results 155 include “Good morning Patrick, how” assigned to the “<spk: 1>” identity-agnostic speaker token 165 and “are you? Good, good. How are you Tom? Pretty” assigned to the “<spk: 2>” identity-agnostic speaker token 165. In this example, it is apparent from a semantic or linguistic interpretation that the terms “are you” and “Pretty” were not spoken by speaker 2, but speaker 1. Yet, in some examples, the joint speech recognition and speaker diarization model 150 does perform semantic interpretation when producing the diarization results 155 such that the diarization results 155 are especially susceptible to these few-word off errors when operating on a frame-by-frame basis. Notably, however, these few-word off errors may be readily identifiable by performing semantic interpretation upon the diarization results 155. To that end, in the third configuration 500, the diarization prompt 116 requests the LLM 170 to correct misplaced words from the diarization results 155. More specifically, the diarization prompt 116 requests the LLM 170 to “correct misplaced words and move them to the right speaker.”

In the example shown, the LLM 170 processes the diarization results 155 and is conditioned on the diarization prompt 116 to generate the updated diarization results 175. In the example shown, the updated diarization results 175 do not replace the identity-agnostic speaker tokens 165 and only correct which speech recognition results 120 are assigned to each identity-agnostic speaker token 165. However, in other examples, the updated diarization results 175 may replace the identity-agnostic speaker tokens 165 with identity-specific speaker tokens 172 (e.g., as shown in the first and second configurations 300, 400 (FIGS. 3 and 4)) in addition to correcting the speech recognition results 120. The LLM 170 processes the diarization results 155 by semantically interpreting the speech recognition results 120 assigned to each identity-agnostic speaker token 165. More specifically, the LLM 170 identifies a predicted term (or predicted terms) from the speech recognition results 120 that is misaligned with a corresponding identity-agnostic speaker token 165 using semantic interpretation. Put another way, the LLM 170 identifies predicted terms that are aligned with incorrect identity-agnostic speaker tokens 165. Thereafter, the LLM 170 realigns the identified predicted term with another one of the identity-agnostic speaker tokens 165 (e.g., the correct identity-agnostic speaker token 165). Finally, the LLM 170 generates the updated diarization results 175 based on the realigned predicted term that is now aligned with the correct identity-agnostic speaker token 165.

In the example shown, the LLM 170 processes “<spk: 1> Good morning Patrick, how <spk: 2> are you? Good, good. How are you Tom? Pretty <spk: 1> good. Going to work?<spk: 2> Yes. Busy day” to identify that the predicted terms “are you?” and “Pretty” are misaligned with the speaker tokens associated with the second speaker rather than the first speaker based on semantic interpretation. Accordingly, the LLM 170 realigns these identified predicted terms to the identity-agnostic speaker token 165 of “<spk: 1>.” Finally, the LLM 170 generates the updated diarization results 175 based on the realigned predicted terms. Advantageously, the LLM 170 is able to perform semantic interpretation on the diarization results 155 to correct any misaligned speech recognition results 120 near speaker turns.

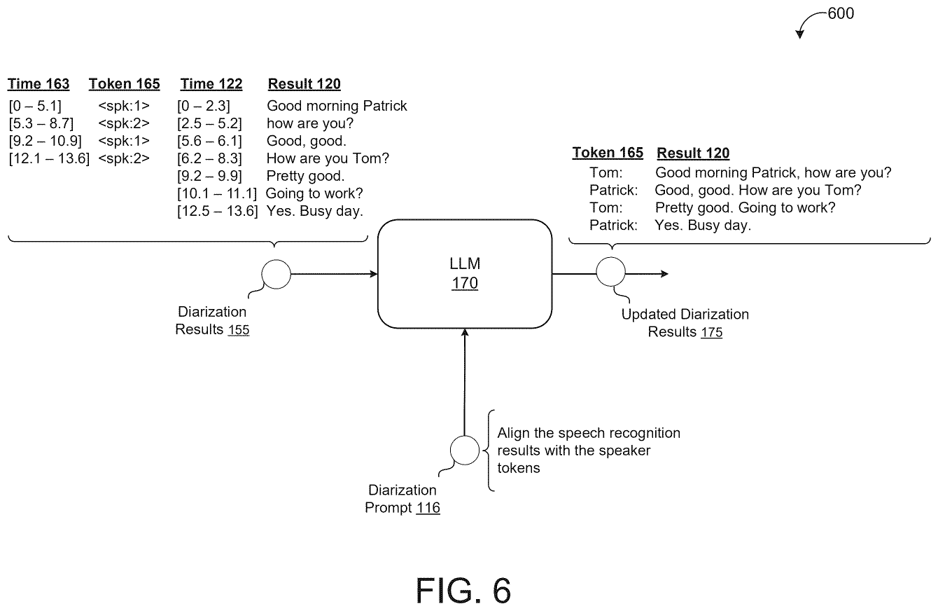

FIG. 6 illustrates a fourth configuration 600 of the LLM 170 performing post-processing on the diarization results 155. In the fourth configuration 600, the LLM 170 receives diarization results 155 generated from a conversation between two speakers, Patrick and Tom. Here, the diarization results 155 include the identity-agnostic speaker tokens 165 and corresponding speech recognition results 120. The identity-agnostic speaker tokens 165 and corresponding speech recognition results 120 of the diarization results 155 may not be aligned. Moreover, the diarization results 155 include speaker token timestamps 163 corresponding to the identity-agnostic speaker tokens 165 and speech timestamps 122 corresponding to the speech recognition results 120. In the example shown, a first identity-agnostic speaker token 165 has a starting speaker token timestamp 163 of 0 and an ending speaker token timestamp 163 of 5.1, a second identity-agnostic speaker token 165 has a starting speaker token timestamp 163 of 5.3 and an ending speaker token timestamp 163 of 8.7, a third identity-agnostic speaker token 165 has a starting speaker token timestamp 163 of 9.2 and an ending speaker token timestamp 163 of 10.9, and a fourth identity-agnostic speaker token 165 has a starting speaker token timestamp 163 of 12.1 and an ending speaker token timestamp 163 of 13.6. Moreover, a first speech recognition result 122 has a starting speech timestamp 122 of 0 and an ending speech timestamp of 2.3, a second speech recognition result 122 has a starting speech timestamp 122 of 2.5 and an ending speech timestamp of 5.2, a third speech recognition result 122 has a starting speech timestamp 122 of 5.6 and an ending speech timestamp of 6.1, and so on. Thus, the diarization results 155 in the fourth configuration 600, include identity-agnostic speaker tokens 165 and speech recognition results 120 that are not aligned. That is, it is not immediately apparent from the diarization results 155 which identity-agnostic speaker token 165 corresponds to which speech recognition result. Moreover, the speaker token timestamps 163 and the speech timestamps 122 are not perfectly aligned such that it is not readily apparent which speech recognition results 120 correspond to which identity-agnostic speaker tokens 165.

To that end, in the fourth configuration 600, the diarization prompt 116 requests the LLM 170 to orchestrate (i.e., align) the speech recognition results 120 including speech timestamps 122 with the identity-agnostic speaker tokens 165 including speaker token timestamps 163. In some implementations, the diarization prompt 116 includes a single-shot (or few-shot) learning example as part of the diarization prompt 116. The single-shot learning example may include an example input and output for conditioning the LLM 170. In particular, the single-shot learning example may include example diarization results 155 and example updated diarization results 175 that serve as an example for the LLM 170 to reference while generating the updated diarization results 175. To that end, the LLM 170 is conditioned upon the diarization prompt 116 that may include the single-shot learning example to generate the updated diarization results 175 based on the diarization results 155. In particular, the LLM 170 initially aligns the speech timestamps 122 with the speaker token timestamps 163. Put another way, the LLM 170 aligns the speech timestamps 122 with the speaker token timestamps that have overlapping ranges of time. In the example shown, the first speech recognition result 122 has a starting speech timestamp 122 of 0 and an ending speech timestamp of 2.3 and the second speech recognition result 122 has a starting speech timestamp 122 of 2.5 and an ending speech timestamp of 5.2. Here, the speech timestamps 122 of both the first and second speech recognition results 120 overlap with the first identity-agnostic speaker token 165 which has a starting speaker token timestamp 163 of 0 and an ending speaker token timestamp 163 of 5.1. As such, the LLM 170 aligns the first and second speech recognition results 120 with the first identity-agnostic speaker token 165 of “<spk: 1>”

Although the first, second, third, and fourth configuration 300, 400, 500, 600 are shown as operating independently from one another, the LLM 170 may perform one or more of the configurations in parallel or sequentially. For instance, the LLM 170 may receive a diarization prompt 116 to replace the identity-agnostic speaker tokens 165 with identity-specific speaker tokens 172 and also replace any few-word off errors. In some implementations, the diarization prompt 116 only includes the task for the LLM 170 perform (e.g., replace identity-agnostic speaker tokens 165 with identity-specific speaker tokens 172). In other implementations, the diarization prompt 116 includes the single-shot or few-shot learning example in addition to the task for the LLM 170 to perform. Moreover, the diarization prompt 116 may include context data associated with the audio that the speech recognition and speaker diarization model 150 processes. For instance, the context data may include a video description when the audio data corresponds to a video, user profile information of a user requesting the diarization results, and/or a state of the user device.

In some implementations, the LLM 170 is pre-trained on a diverse range of text data sourced from web documents, books, and code. As such, the LLM 170 may include about a billion parameters in total. The LLM 170 may include a transformer architecture. The LLM 170 may include the Pathway Language Model 2 (PaLM 2) that uses a 156K sentence piece model for tokenization and transformer input dimension of 1536. In some examples, the LLM 170 is fine-tuned to post-process the diarization results 155 and generate the updated diarization results 175. That is, the parameters of the LLM 170 learned during training are frozen and a subset of additional parameters of the LLM 170 are updated to perform the task of post-processing diarization results. More specifically, the LLM 170 may be fine-tuned using training samples each including example diarization results 155 and diarization prompts 116 as input data and paired with a corresponding updated diarization result 175 as output data. Thus, during fine-tuning, the LLM 170 processes the example diarization results 155 and the diarization prompts 116 to produce a predicted update diarization result. Thereafter, the training process compares the predicted updated diarization result with the corresponding updated diarization result 175 from the training sample to determine a loss. Based on the loss determined for each training sample, the training process fine-tunes the additional parameters of the LLM 170. Accordingly, fine-tuning the LLM 170 teaches the LLM 170 to accurately generate updated diarization results 175.

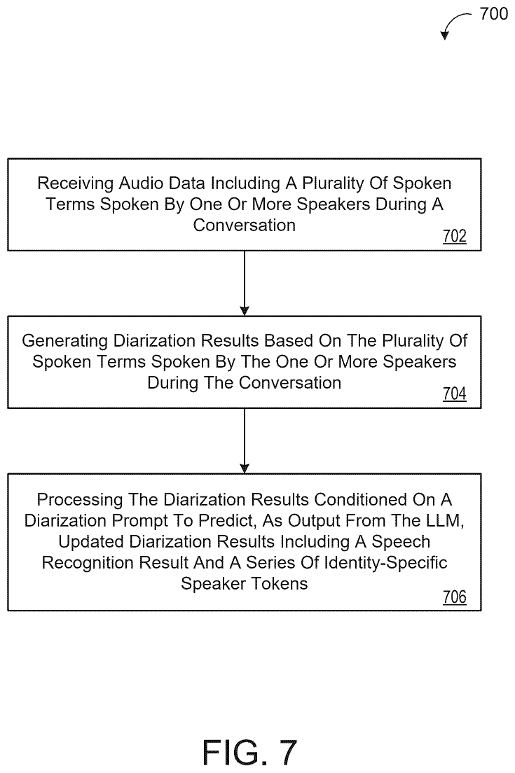

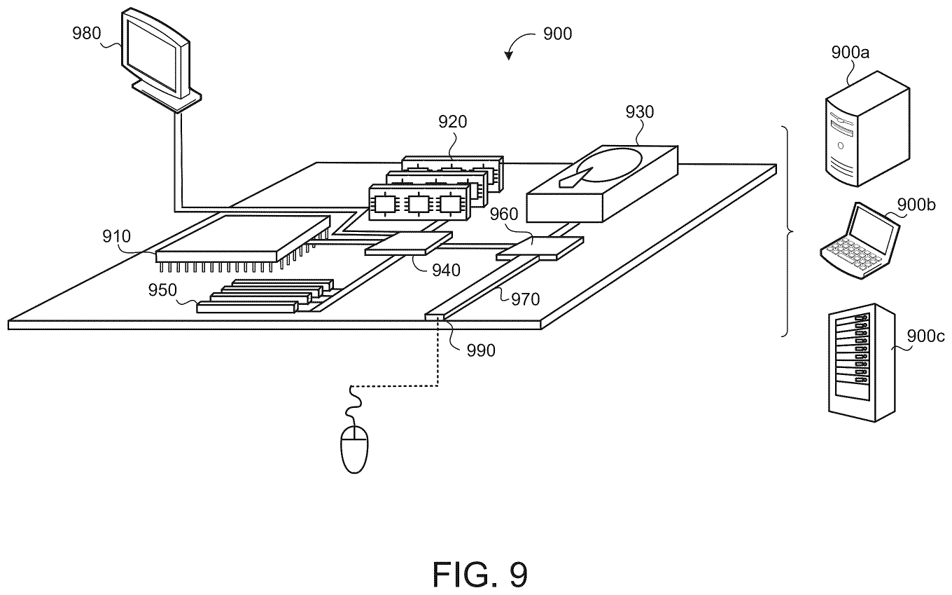

FIG. 7 illustrates a flowchart of an example arrangement of operations for a computer-implemented method 700 of performing speaker diarization post-processing using an LLM 170. The method 700 may execute on data processing hardware 910 (FIG. 9) using instructions stored on memory hardware 920 (FIG. 9). The data processing hardware 910 and the memory hardware 920 may reside on the user device 110 and/or the remote system 140 of FIG. 1 each corresponding to a computing device 900 (FIG. 9).

At operation 702, the method 700 includes receiving audio data 108 including a plurality of spoken terms spoken by one or more speakers 10 during a conversation. At operation 704, the method 700 includes generating, using a joint speech recognition and speaker diarization model 150, diarization results 155 based on the plurality of spoken terms spoken by the one or more speakers 10 during the conversation. The diarization results 155 include a speech recognition result 120 including a series of predicted terms and a series of identity-agnostic speaker tokens 165. Each respective predicted term from the series of predicted terms is aligned with a corresponding identity-agnostic speaker token 165 from the series of identity-agnostic speaker tokens 165. Each corresponding identity-agnostic speaker token 165 represents a generic identity of a respective one of the speakers 10 that spoke the respective predicted term. At operation 706, the method 700 includes processing, using an LLM 170, the diarization results 155 conditioned on a diarization prompt 116 to predict, as output from the LLM 170, updated diarization results 175. In some examples, the LLM 170 is conditioned on the diarization prompt 116 to generate the updated diarization results 175. The updated diarization results 175 include the speech recognition result 120 including the series of predicted terms and a series of identity-specific speaker tokens 172. Each respective predicted term from the series of predicted terms is aligned with a corresponding identity-specific speaker token 172 from the series of identity-specific speaker tokens 172. Each corresponding identity-specific speaker token 172 represents a particular identity of a respective one of the speakers 10 that spoke the respective predicted term.

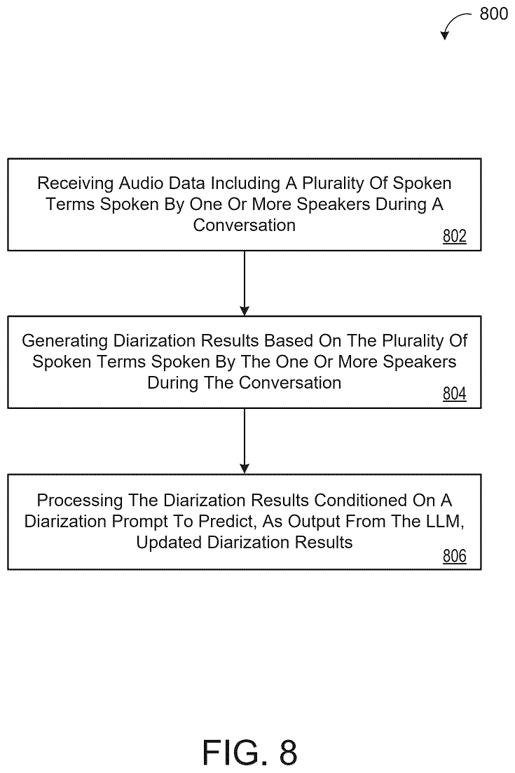

FIG. 8 illustrates a flowchart of an example arrangement of operations for another computer-implemented method 800 of performing speaker diarization post-processing using an LLM 170. The method 800 may execute on data processing hardware 910 (FIG. 9) using instructions stored on memory hardware 920 (FIG. 9). The data processing hardware 910 and the memory hardware 920 may reside on the user device 110 and/or the remote system 140 of FIG. 1 each corresponding to a computing device 900 (FIG. 9).

At operation 802, the method 800 includes receiving audio data 108 including a plurality of spoken terms spoken by one or more speakers 10 during a conversation. At operation 804, the method 800 includes generating, using a joint speech recognition and speaker diarization model 150, diarization results 155 based on the plurality of spoken terms spoken by the one or more speakers 10 during the conversation. The diarization results 155 include a speech recognition result 120 including a series of predicted terms and a series of identity-agnostic speaker tokens 165. At operation 806, the method 800 includes processing, using an LLM 170, the diarization results 155 conditioned on a diarization prompt 116 to predict, as output from the LLM 170, updated diarization results 175. In some examples, the LLM 170 is conditioned on the diarization prompt 116 to generate the updated diarization results 175.

Traditional speaker diarization systems often struggle with accurately identifying and segmenting speakers in audio streams, especially in environments with overlapping speech or multiple speakers. By leveraging LLMs, the joint speech recognition and speaker diarization model 150 enhances the accuracy of the diarization results 155 by refining the initial output. This post-processing step involves replacing identity-agnostic speaker tokens 165 with identity-specific speaker tokens 172, which represent the actual identities or roles of the speakers. This approach not only improves the precision of speaker identification but also ensures that the diarization results are more meaningful and contextually relevant. Moreover, the joint speech recognition and speaker diarization model 150 uses the LLM 170 to process the diarization results 155 to identify and correct misaligned predicted terms using contextual understanding. This capability is particularly advantageous in scenarios where speaker turns are not clearly delineated, leading to few-word off errors. By realigning these misaligned terms with the correct speaker tokens, the joint speech recognition and speaker diarization model 150 ensures that the updated diarization results 175 accurately reflect who spoke each term. Thus, the semantic interpretation significantly reduces errors and enhances the overall reliability of the diarization process.

FIG. 9 is a schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910, memory 920, a storage device 930, a high-speed interface/controller 940 connecting to the memory 920 and high-speed expansion ports 950, and a low speed interface/controller 960 connecting to a low speed bus 970 and a storage device 930. Each of the components 910, 920, 930, 940, 950, and 960, are interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high speed controller 940 manages bandwidth-intensive operations for the computing device 900, while the low speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers 900a, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving audio data comprising a plurality of spoken terms spoken by one or more speakers during a conversation;
generating, using a joint speech recognition and speaker diarization model, diarization results based on the plurality of spoken terms spoken by the one or more speakers during the conversation, the diarization results comprising:
a speech recognition result comprising a series of predicted terms; and
a series of identity-agnostic speaker tokens, wherein each respective predicted term from the series of predicted terms is aligned with a corresponding identity-agnostic speaker token from the series of identity-agnostic speaker tokens and each corresponding identity-agnostic speaker token represents a generic identity of a respective one of the speakers that spoke the respective predicted term; and
processing, using a large language model (LLM), the diarization results conditioned on a diarization prompt to predict, as output from the LLM, updated diarization results comprising:
the speech recognition result comprising the series of predicted terms; and
a series of identity-specific speaker tokens, wherein each respective predicted term from the series of predicted terms is aligned with a corresponding identity-specific speaker token from the series of identity-specific speaker tokens and each corresponding identity-specific speaker token representing a particular identity of a respective one of the speakers that spoke the respective predicted term.

2. The computer-implemented method of claim 1, wherein the corresponding identity-specific speaker token does not reveal the particular identity of the respective one of the speakers that spoke the respective predicted term.

3. The computer-implemented method of claim 1, wherein the particular identity comprises a name or role of the respective one of the speakers that spoke the respective predicted term.

4. The computer-implemented method of claim 1, wherein processing the diarization results to predict updated diarization results comprises replacing the identity-agnostic speaker tokens with identity-specific speaker tokens.

5. The computer-implemented method of claim 1, wherein processing the diarization results to predict updated diarization results comprises:
identifying, from the diarization results, a predicted term misaligned with a corresponding identity-agnostic speaker token using semantic interpretation;
realigning the identified predicted term with another one of the identity-agnostic speaker tokens from the series of identity-agnostic speaker tokens; and
generating the updated diarization results based on the realigned predicted term.

6. The computer-implemented method of claim 1, wherein the LLM is pre-trained on a diverse range of text data sourced from web documents, books, and code.

7. The computer-implemented method of claim 1, wherein the operations further comprise fine-tuning the LLM on training examples to perform post-processing on the diarization results.

8. The computer-implemented method of claim 1, wherein the diarization prompt comprises a single-shot learning example.

9. The computer-implemented method of claim 8, wherein the single-shot learning example comprises an example input and output for conditioning the LLM.

10. The computer-implemented method of claim 1, wherein the diarization prompt comprises context data associated with the conversation.

11. A system comprising:
data processing hardware; and
memory hardware in communication with the data processing hardware, the memory hardware storing instructions that when executed on the data processing hardware cause the data processing hardware to perform operations comprising:
receiving audio data comprising a plurality of spoken terms spoken by one or more speakers during a conversation;
generating, using a joint speech recognition and speaker diarization model, diarization results based on the plurality of spoken terms spoken by the one or more speakers during the conversation, the diarization results comprising:
a speech recognition result comprising a series of predicted terms; and
a series of identity-agnostic speaker tokens, wherein each respective predicted term from the series of predicted terms is aligned with a corresponding identity-agnostic speaker token from the series of identity-agnostic speaker tokens and each corresponding identity-agnostic speaker token representing a generic identity of a respective one of the speakers that spoke the respective predicted term; and
processing, using a large language model (LLM), the diarization results conditioned on a diarization prompt to predict, as output from the LLM, updated diarization results comprising:
the speech recognition result comprising the series of predicted terms; and
a series of identity-specific speaker tokens, wherein each respective predicted term from the series of predicted terms is aligned with a corresponding identity-specific speaker token from the series of identity-specific speaker tokens and each corresponding identity-specific speaker token representing a particular identity of a respective one of the speakers that spoke the respective predicted term.

12. The system of claim 11, wherein the corresponding identity-specific speaker token does not reveal the particular identity of the respective one of the speakers that spoke the respective predicted term.

13. The system of claim 11, wherein the particular identity comprises a name or role of the respective one of the speakers that spoke the respective predicted term.

14. The system of claim 11, wherein processing the diarization results to predict updated diarization results comprises replacing the identity-agnostic speaker tokens with identity-specific speaker tokens.

15. The system of claim 11, wherein processing the diarization results to predict updated diarization results comprises:
identifying, from the diarization results, a predicted term misaligned with a corresponding identity-agnostic speaker token using semantic interpretation;
realigning the identified predicted term with another one of the identity-agnostic speaker tokens from the series of identity-agnostic speaker tokens; and
generating the updated diarization results based on the realigned predicted term.

16. The system of claim 11, wherein the LLM is pre-trained on a diverse range of text data sourced from web documents, books, and code.

17. The system of claim 11, wherein the operations further comprise fine-tuning the LLM on training examples to perform post-processing on the diarization results.

18. The system of claim 11, wherein the diarization prompt comprises a single-shot learning example.

19. The system of claim 18, wherein the single-shot learning example comprises an example input and output for conditioning the LLM.

20. The system of claim 11, wherein the diarization prompt comprises context data associated with the conversation.
